(19) United States
(12) Patent Application Publication
(10) Pub. No.: US 2024/0084229 A1
(43) Pub. Date: Mar. 14, 2024

(54) DETERGENT COMPOSITION COMPRISING, AS THICKENING AGENT, A COMPOSITION HAVING POLAR MEDIA THICKENING PROPERTIES

(71) Applicant: Societe d'Exploitation de Produits Pour les Industries Chimiques Seppic, PARIS CEDEX 07 (FR)

(72) Inventors: Miruna BODOC, Castres (FR); Stéphane MONTEILLET, Castres (FR)

(21) Appl. No.: 18/260,300

(22) PCT Filed: Dec. 22, 2021
(86) PCT No.: PCT/EP2021/087359

§ 371 Date: Jul. 3, 2023

(30) Foreign Application Priority Data
Jan. 7, 2021 (FR) FR2100111

(51) Int. Cl. C11D 17/00; C11D 3/37; C11D 11/00

(52) U.S. Cl. CPC C11D 17/0026; C11D 3/3719; C11D 11/0023

(57) ABSTRACT

Detergent composition (F) for domestic or industrial use, comprising at least one detergent surfactant and, as thickening agent, a composition (CA) in the form of a self-reversible water-in-oil-type emulsion comprising, for 100% of its mass, a mass content of greater than or equal to 20% of a polymer (P) consisting of monomer units derived from glutamic acid (GA), partially or totally salified, and units derived from at least one cross-linking agent (AR) bearing at least two glycidyl functions.

The present invention relates to a detergent composition (F) comprising at

least one surfactant and, as thickening agent, a composition (C_{A}) in the form of an emulsion of self-invertible water-in-oil type and to the process for preparing such a composition.

Polymers are widely used today in detergent compositions and represent the second most widely used family of products in compositions of this type. Detergent compositions contain polar phases, for example phases consisting of water, and in most cases require the use of rheology modifiers, for example polymers, to increase the viscosity of these polar phases, and also to impart well-defined rheological behavior.

Among the polymers that modify the rheology of polar phases, mention may be made of natural polymers, for example polysaccharides based on monosaccharides or polysaccharides based on monosaccharide derivatives, or else synthetic polymers of linear or branched, crosslinked or noncrosslinked, anionic or cationic or amphiphilic polyelectrolyte type. Predominantly present on the market, synthetic polymers have the property of being deployed, in the polar phase, under the effect of electrostatic repulsions due to the presence of charges (negative and/or positive) on the linear or branched, crosslinked or noncrosslinked polymer backbone. These rheology modifiers bring both an increase in the viscosity of the polar phase, and also a certain consistency and/or a stabilizing effect imparted to the detergent composition.

In order to meet the needs of formulators and to improve performance, various recent scientific studies have reported the development of new, innovative and varied polymeric systems. Thus, the polymers used in the detergent industries can play a functional role as film-forming agents, rheology modifiers, enabling stabilization of the fatty phases in emulsions of water-in-oil type and of the oil-in-water type, stabilization of solid particles (pigments and fillers) or as agents having an impact on the appearance of the formula (transparency, translucency, opacity).

Polymers that modify the rheology of polar phases, and more particularly of aqueous phases, are mainly polyelectrolytes resulting from the free-radical polymerization of (meth)acrylic monomers, i.e. acrylic acid or methacrylic acid, ester derivatives of acrylic acid or methacrylic acid, or else derivatives of acrylamide or methacrylamide.

Developing new biobased and biodegradable rheology modifiers that are as efficient as the synthetic polymers currently used still constitutes a major challenge today. Indeed, until now the solutions mainly used for thickening aqueous phases involve ingredients originating from petrochemical materials and in particular acrylic acid and derivatives thereof, or methacrylic acid and derivatives thereof.

Given the growing consumer concern for a sustainable and responsible economy and development, the replacement of raw materials of petrochemical origin with raw materials of renewable origin for preparing polymers is a priority research area.

To date, the literature has described the use of various natural polymers or polymers originating from renewable raw materials, the monomer units of which come from the family of sugars (glucose, arabinose, xylose, galactose, mannose, ribose, glucuronic acid, etc.) or from the family of amino acids (glutamic acid, aspartic acid, lysine, etc.). These polymers are mostly linear or branched depending on the plant from which they come or according to their manufacturing process.

As an example of a polymer of natural origin, mention may be made of polyglutamic acid (PGA), which is currently the subject of numerous research studies. It is a predominantly linear polymer and consists of glutamic acid (GA) monomer units. Glutamic acid is an amino acid characterized by an amine function in the a position and by two carboxylic acid functions (or carboxylates depending on the pH) in the a and y positions (cf. chemical formula No. 1).

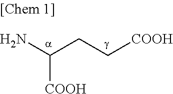

### Chemical Structure of Glutamic Acid (GA)

One of the ways to increase the branching of a synthetic or natural polymer or of a polymer of natural origin consists in performing crosslinking reactions. The aim of the crosslinking of the polymer chains is to connect several polymer chains to one another which, when added to a polar phase, and more particularly to water, take the form of a three-dimensional network that is insoluble in water but is water-swellable, thus resulting in a chemical gel being obtained.

Crosslinked polymers may be prepared:
in one step by reacting the monomers and the crosslinking agent during the polymerization reaction, or
in at least two steps, the first of which consists in preparing the polymer, and the second consists in reacting the polymer with a crosslinking agent to obtain a crosslinked polymer.

Various reactions exist for the crosslinking of polyglutamic acid (PGA), which makes it possible to obtain polymers of natural origin with improved thickening properties in polar media, and notably in aqueous media. Among the crosslinking agents known to be used in the (PGA) crosslinking reaction, polyepoxide derivatives are the most widely described since they make it possible to carry out crosslinking processes under environmentally friendly conditions (moderate temperatures, reaction in aqueous media and in the absence of harmful solvents).

However, the implementation of these processes requires diluting the (PGA) to high levels, which leads to the production of an aqueous gel comprising, per 100% of its mass, a content by mass of less than or equal to 10% of a polymer (P), which is difficult for formulators to implement.

Proceeding from this, a problem that arises is that of providing an easy-to-use detergent composition comprising polymers of natural origin, the raw materials of which are renewable and which have thickening properties for polar media and particularly for aqueous media.

One solution of the present invention is a detergent composition (F) for domestic or industrial use comprising at least one detergent surfactant and, as thickening agent, a composition (C_{A}) in the form of an emulsion of self-invertible water-in-oil type comprising, per 100% of its mass, a content by mass of greater than or equal to 20% of a polymer (P) consisting of monomer units derived from partially or totally salified glutamic acid (GA) and of units derived from at least one crosslinking agent (XLA) bearing at least two glycidyl functions.

For the purposes of the present invention, the term “detergent surfactants” denotes surfactants that give the detergent liquid aqueous composition (F) its ability to remove soiling present on the solid surfaces and to keep it in suspension, in order for it to then be removed during the rinsing step.

For the purposes of the present invention, the term “emulsion of water-in-oil type” denotes a heterogeneous mixture of two immiscible liquids, one being dispersed in the form of small droplets in the other, said mixture being thermodynamically unstable and stabilized by the presence of a surfactant system comprising at least one emulsifying surfactant.

For the purposes of the present invention, the term “emulsion of self-invertible water-in-oil type” denotes an emulsion of water-in-oil type as defined above, in which the emulsifying surfactants present give the emulsion a hydrophilic-lipophilic balance (HLB) such that, once said emulsion has been added to a polar phase, for instance water, the direction of the emulsion will change from water-in-oil form to oil-in-water form, thereby placing the polymer (P) in contact with the polar phase to be thickened.

In the polymer (P) present in the composition (C_{A}) which is the subject of the present invention, the monomer units derived from partially or totally salified glutamic acid (GA) are linked together:
either in such a way that the amine function of a glutamic acid (GA) monomer unit is covalently bonded with the carboxylic function located in the alpha (α) position of a second glutamic acid (GA) monomer unit; the resulting polymer is then called partially or totally salified “α-polyglutamic acid” or PAGA (cf. chemical formula No. 2),

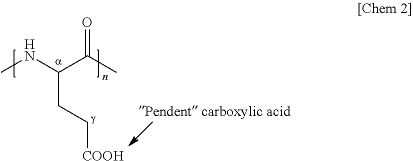

### Chemical Structure of α-Polyglutamic Acid or PAGA.

or in such a way that the amine function of a glutamic acid (GA) monomer unit is covalently bonded to the carboxylic function of the side chain located in the gamma (γ) position of a second glutamic acid (GA) monomer unit; the resulting polymer is then called partially or totally salified “γ-polyglutamic acid” or PGGA (cf. chemical formula No. 3).

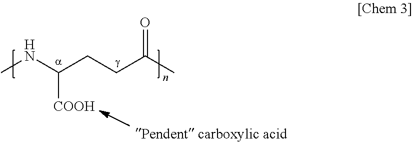

### Chemical Structure of γ-Polyglutamic Acid or PGGA.

In general, PGA may be prepared chemically according to peptide synthesis methods known to those skilled in the art, in particular proceeding via steps of selective protection, activation, coupling and deprotection. The coupling generally consists of a nucleophilic attack of the amine function of a glutamic acid monomer unit on an activated carboxylic acid function of another glutamic acid monomer unit.

PGGA can also be obtained via processes comprising at least one microbial fermentation step involving the use of at least one bacterial strain.

For the purposes of the present invention, in the polymer (P) as defined previously, the term “salified” indicates that the “pendent” carboxylic acid function present on each glutamic acid (GA) monomer unit of the polymer (in the gamma position in the case of PAGA or in the alpha position in the case of PGGA) is in an anionic or carboxylate form. The counterion of this carboxylate function is a cation derived, for example, from alkali metal salts such as sodium, potassium or salts of nitrogenous bases such as amines, lysine or monoethanolamine (HO—CH₂—CH₂—NH₂).

According to one particular aspect, in the composition (C_{A}) which is the subject of the present invention, the content by mass of the polymer (P) is greater than or equal to 20% and less than or equal to 60%, and more particularly greater than or equal to 20% and less than or equal to 40%.

PGGA can exist in different conformational forms in solution in water. These forms depend on the inter- and intra-molecular hydrogen bonds and thus on the pH, the polymer concentration, the ionic strength of the solution, and also the temperature. The PGGA chains may thus take the form of α helix, β sheet, aggregates or else be in a disordered and random state.

According to one particular aspect, in the composition (C_{A}) which is the subject of the present invention, the polymer (P) is in a helical conformation when it is present in a solution at a content by mass of less than or equal to 0.1% and of which said solution has a pH of less than or equal to 7.

According to one particular aspect, in the composition (C_{A}) which is the subject of the present invention, the polymer (P) is in sheet conformation when it is present in a solution at a content by mass of less than or equal to 0.1% and of which said solution has a pH of greater than 7.

For the purposes of the present invention, the term “crosslinking agent (XLA)” denotes a chemical molecule the structure of which enables it to bond covalently to at least two polymer chains.

For the purposes of the present invention, the term “crosslinking agent (XLA) bearing at least two glycidyl functions” denotes a crosslinking agent (XLA) as defined above, the molecular structure of which comprises at least two glycidyl units or functions of formula (I′):

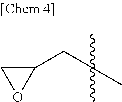 [SMILES: *CC1CO1]

### (I′)

The crosslinking of the polymer chains of the polymer (P) is performed according to a reaction between the terminal free amine function (—NH₂) and/or one or more “pendent” or terminal carboxylic or carboxylate functions (—COOH or —COO^{—}) present in the structure of said polymer (P), and at least one epoxy group present in the structure of the crosslinking agent (XLA) bearing at least two glycidyl functions.

The crosslinking agent (XLA) may be chosen from the members of the group consisting of:

Ethylene glycol diglycidyl ether of formula (I):

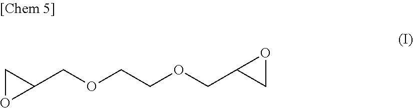 [SMILES: C(COCC1CO1)OCC1CO1]

The compound of formula (II):

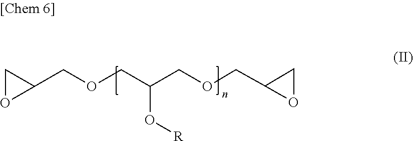

with R representing a hydrogen atom or the glycidyl radical

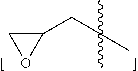

and n representing an integer of greater than or equal to 1 and less than or equal to 10,

When R represents a hydrogen atom and n is equal to 1, the compound of formula (II) is more particularly the compound of formula (IIa) or glycerol diglycidyl ether:

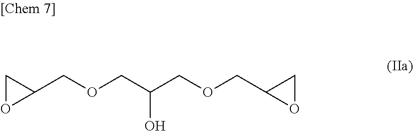 [SMILES: OC(COCC1CO1)COCC1CO1]

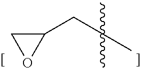 [SMILES: *CC1CO1]

When R represents the glycidyl radical and n is equal to 1, the compound of formula (II) is more particularly the compound of formula (IIb) or glycerol triglycidyl ether:

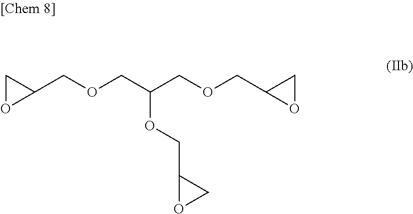 [SMILES: C(OCC1CO1)C(COCC1CO1)OCC1CO1]

When R represents a hydrogen atom and n is equal to 2, the compound of formula (II) is more particularly the compound of formula (IIc) or diglycerol diglycidyl ether:

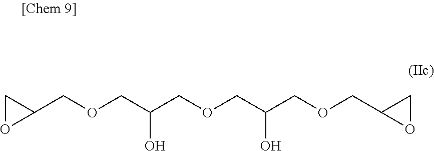 [SMILES: OC(COCC(O)COCC1CO1)COCC1CO1]

When R represents the glycidyl radical

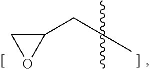 [SMILES: *CC1CO1]

and n is equal to 2, the compound of formula (II) is more particularly the compound of formula (IId) or diglycerol tetraglycidyl ether:

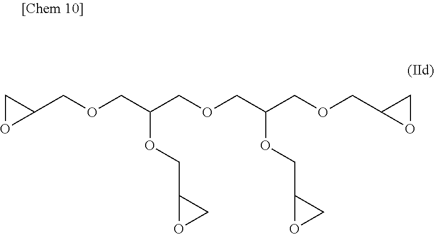 [SMILES: C(OCC(COCC1CO1)OCC1CO1)C(COCC1CO1)OCC1CO1]

1,3-Propanediol diglycidyl ether of formula (III):

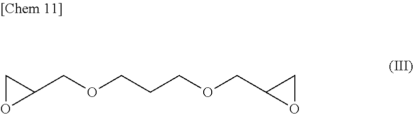 [SMILES: C(COCC1CO1)COCC1CO1]

1,2-Propanediol diglycidyl ether of formula (IV):

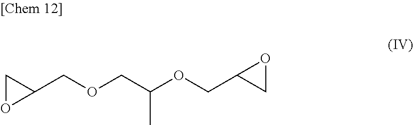

1,4-Butanediol diglycidyl ether of formula (V):

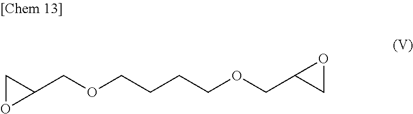 [SMILES: C(CCOCC1CO1)COCC1CO1]

1,2-Butanediol diglycidyl ether of formula (VI):

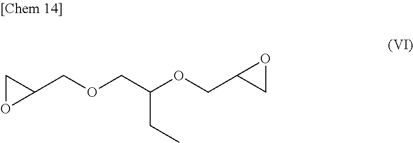

1,3-Butanediol diglycidyl ether of formula (VII):

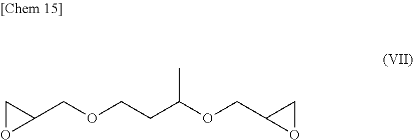

1,6-Hexanediol diglycidyl ether of formula (VIII):

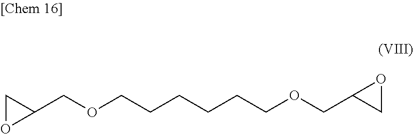 [SMILES: C(CCCOCC1CO1)CCOCC1CO1]

The compound of formula (IX):

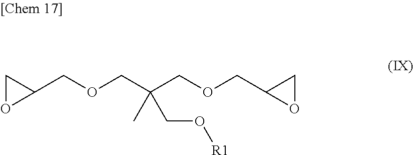

with R₁ representing a hydrogen atom or the glycidyl radical

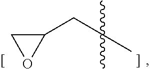 [SMILES: *CC1CO1]

When R₁ represents a hydrogen atom, the compound of formula (IX) is more particularly the compound of formula (IXa) or trimethylolethane diglycidyl ether:

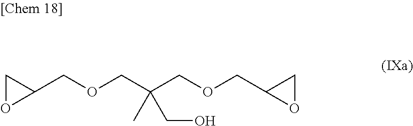 [SMILES: CC(CO)(COCC1CO1)COCC1CO1]

When R₁ represents the glycidyl radical

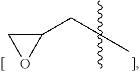 [SMILES: *CC1CO1]

the compound of formula (IX) is more particularly the compound of formula (IXb) or trimethylolethane triglycidyl ether:

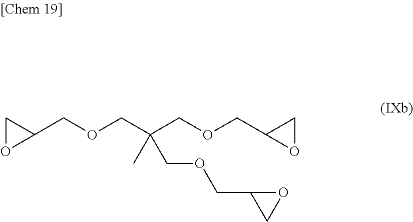 [SMILES: CC(COCC1CO1)(COCC1CO1)COCC1CO1]

The compound of formula (X):

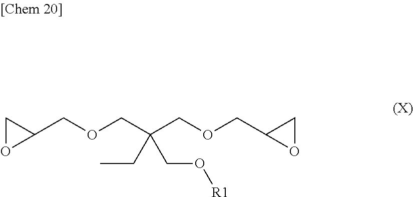

with R₁ representing a hydrogen atom or the glycidyl radical

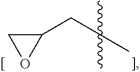 [SMILES: *CC1CO1]

When R₁ represents a hydrogen atom, the compound of formula (X) is more particularly the compound of formula (Xa) or trimethylolpropane diglycidyl ether:

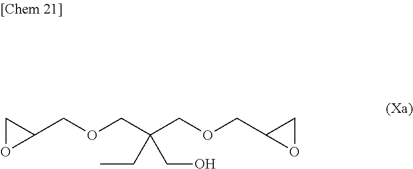 [SMILES: CCC(CO)(COCC1CO1)COCC1CO1]

When R₁ represents the glycidyl radical

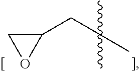 [SMILES: *CC1CO1]

the compound of formula (X) is more particularly the compound of formula (Xb) or trimethylolpropane triglycidyl ether:

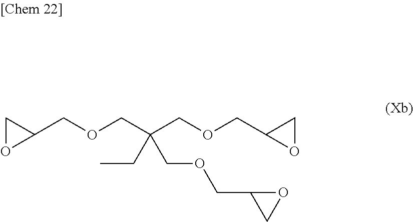 [SMILES: CCC(COCC1CO1)(COCC1CO1)COCC1CO1]

The compound of formula (XI):

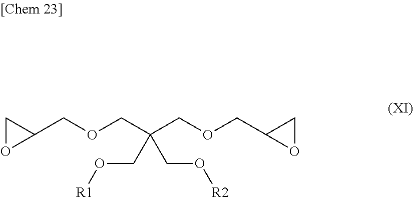

with R₁ and R₂ independently representing a hydrogen atom or the glycidyl radical

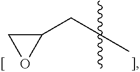 [SMILES: *CC1CO1]

When R₁ and R₂ each represent a hydrogen atom, the compound of formula (XI) is more particularly the compound of formula (XIa) or pentaerythritol diglycidyl ether:

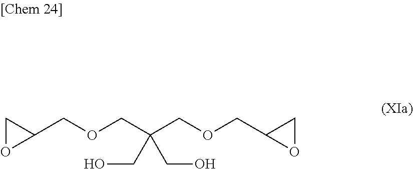 [SMILES: OCC(CO)(COCC1CO1)COCC1CO1]

When R₁ represents a hydrogen atom and R₂ represents the glycidyl radical

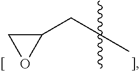 [SMILES: *CC1CO1]

the compound of formula (XI) is more particularly the compound of formula (XIb) or pentaerythritolorooane triglycidyl ether:

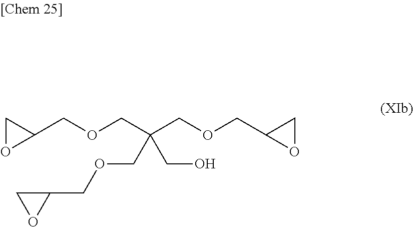 [SMILES: OCC(COCC1CO1)(COCC1CO1)COCC1CO1]

When R₁ and R₂ each represent the glycidyl radical

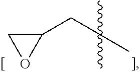 [SMILES: *CC1CO1]

the compound of formula (XI) is more particularly the compound of formula (XIc) or pentaerythritolpropane tetraglycidyl ether:

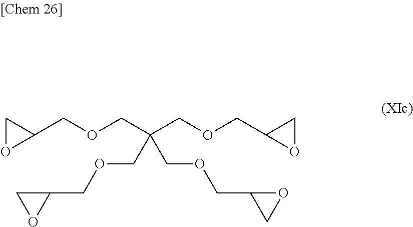 [SMILES: C(OCC(COCC1CO1)(COCC1CO1)COCC1CO1)C1CO1]

The compound of formula (XII):

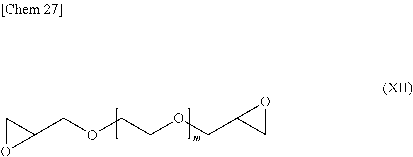

with m representing an integer of greater than or equal to 2,

The compound of formula (XIII):

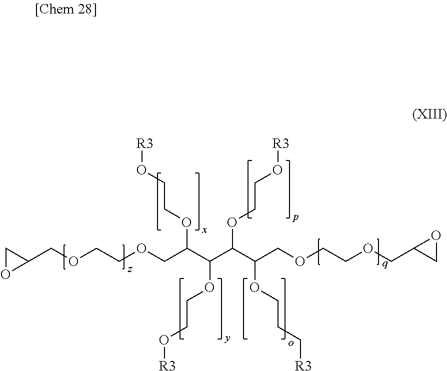

with R₃ representing a hydrogen atom or the glycidyl radical

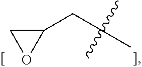 [SMILES: *CC1CO1]

and x, y, z, o, p and q independently of one another representing an integer of greater than or equal to 2 and less than or equal to 10.

Depending on the case, the detergent composition (F) may have one or more of the following characteristics:
the polymer (P) is gamma-polyglutamic acid (PGGA) in acid form or partially or totally salified form.
in the polymer (P), per 100 mol % of monomer units derived from partially or totally salified glutamic acid (GA), the crosslinking agent (XLA) represents from 0.5 to 20 mol %, more particularly from 0.5 to 15 mol % and more particularly still from 0.5 to 12 mol %.
the composition (C_{A}) has a viscosity of between 100 and 10 000 mPa·s (measured with a Brookfield™ RVT viscometer, speed 5 rpm).
the composition (C_{A}) further comprises a monomer unit derived from the compound of formula (X′):

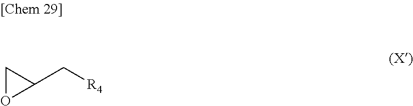

with R4 representing a linear or branched, saturated or unsaturated,

functionalized or non-functionalized hydrocarbon-based radical comprising from 6 to 22 carbon atoms.

According to one particular aspect, R4 represents a hydrocarbon-based radical selected from the elements of the group consisting of heptyl, octyl, nonyl, decyl, undecyl, undecenyl, dodecyl, tridecyl, tetradecyl, pentadecyl, hexadecyl, heptadecyl, octadecyl, hydroxyoctadecyl, oleyl, linoleyl, linolenyl, eicosyl and dodecosyl radicals.

According to another particular aspect, in said polymer (P), per 100% of the mass of monomer units derived from partially or totally salified glutamic acid (GA), the monomer units derived from the compound of formula (X′) represent from 1% to 50% by mass.

The detergent composition (F) comprises between 0.1% and 10% by mass of said composition (C_{A}) and more particularly between 0.1% and 8%.
In the detergent composition (F), the detergent surfactant is selected from anionic, cationic, amphoteric and nonionic detergent surfactants.
Among the anionic detergent surfactants capable of being used for the preparation of the detergent liquid aqueous composition (F) as defined above, mention may be made of alkali metal salts, alkaline-earth metal salts, ammonium salts, amine salts, amino alcohol salts of alkyl ether sulfates, of alkyl sulfates, of alkylamido ether sulfates, of alkylaryl polyether sulfates, of monoglyceride sulfates, of alpha-olefin sulfonates, of paraffin sulfonates, of alkyl phosphates, of alkyl ether phosphates, of alkyl sulfonates, of alkylamide sulfonates, of alkylaryl sulfonates, of alkyl carboxylates, of alkyl sulfosuccinates, of alkyl ether sulfosuccinates, of alkylamide sulfosuccinates, of alkyl sulfoacetates, of alkyl sarcosinates, of acyl isethionates, of N-acyl taurates, of acyl lactylates, of N-acylated derivatives of amino acids, of N-acylated derivatives of peptides, of N-acylated derivatives of proteins, and of fatty acids.
Among the amphoteric detergent surfactants capable of being used for the preparation of the detergent liquid aqueous composition (F) as defined above, mention may be made of alkylbetaines, alkylamidobetaines, sultaines, alkylamidoalkylsulfobetaines, imidazoline derivatives, phosphobetaines, amphopolyacetates and amphopropionates.
Among the cationic detergent surfactants capable of being used for the preparation of the detergent liquid aqueous composition (F) as defined above, mention may particularly be made of quaternary ammonium derivatives.
Among the nonionic detergent surfactants capable of being used for the preparation of the detergent liquid aqueous composition (F) as defined above, mention may particularly be made of alkyl polyglycosides containing a linear or branched, saturated or unsaturated aliphatic radical comprising from 8 to 16 carbon atoms, castor oil derivatives, polysorbates, coconut amides and N-alkylamines.

The present invention also provides a process for preparing a detergent composition (F) comprising the following two distinct steps:
a step A) of preparing the composition (C_{A}), comprising the following substeps:
a) a step of preparing an aqueous solution comprising partially or totally salified polyglutamic acid (PGA), with said aqueous solution comprising, per 100% of its mass, between 5% and 70% by mass of partially or totally salified PGA and a crosslinking agent (XLA) comprising at least two glycidyl functions,
b) a step of adjusting the pH of the aqueous solution obtained in step a) to a pH of between 3 and 11,
c) a step of preparing an organic phase containing at least one volatile oil, at least one non-volatile oil (H) and at least one emulsifying surfactant of water-in-oil type (S₁),
d) a step of pre-emulsification by adding, with stirring, the organic phase obtained in step c) to the aqueous solution obtained in step b),
e) a step of emulsifying the pre-emulsion obtained in step d) by homogenization with stirring,
f) a step of distilling the water and volatile oil contained in the emulsion obtained in step e),
g) a step of adding at least one emulsifying surfactant of oil-in-water type (S₂) so as to obtain the composition (C_{A}),
   a step B) of mixing at least one composition (C_{A}) prepared during step A) with at least one surfactant.
   Depending on the case, the process according to the invention may have one or more of the features below:
   In step a), the partially or totally salified polyglutamic acid is polyglutamic acid in gamma form (PGGA).
In step a), all of the monomer units constituting the gamma-polyglutamic acid (PGGA) are derived from sodium glutamate, potassium glutamate, ammonium glutamate, calcium glutamate, magnesium glutamate or a mixture of these forms.
in step a), the aqueous solution comprises, per 100% of its mass, between 5% and 60% by mass, more particularly between 10% and 50% by mass, of partially or totally salified polyglutamic acid (PGA).
in step a), the crosslinking agent (XLA) is present in proportions by mass of between 0.5% and 10% by mass relative to the mass of polyglutamic acid (PGA).
in step a), the crosslinking agent (XLA) is selected from the members of the group consisting of the compounds of formulae (I), (II), (IIa), (IIb), (IIc), (IId), (III), (IV), (V), (VI), (VII), (VIII), (IX), (IXa), (IXb), (X), (Xa), (Xb), (XI), (XIa), (XIb), (XIc), (XII) and (XIII).
in step a), the aqueous solution further comprises at least one compound of formula (X′):

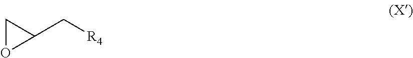

with R₄ representing a linear or branched, saturated or unsaturated, functionalized or non-functionalized hydrocarbon-based radical comprising from 6 to 22 carbon atoms.
According to one particular aspect, R₄ represents a hydrocarbon-based radical selected from the elements of the group consisting of heptyl, octyl, nonyl, decyl, undecyl, undecenyl, dodecyl, tridecyl, tetradecyl, pentadecyl, hexadecyl, heptadecyl, octadecyl, hydroxyoctadecyl, oleyl, linoleyl, linolenyl, eicosyl and dodecosyl radicals.
According to another particular aspect, the content of compound of formula (X′) in the polar solution is, per 100% by mass of said aqueous solution, between 0.05% and 35% by mass, it being understood that the sum of the proportions by mass of the polymer (P), of the crosslinking agent (XLA), of the water and of the compound of formula (X′) is equal to 100%.
In step c), the term “volatile oil” denotes a fatty substance which is liquid at a temperature of 25° C. at atmospheric pressure and the flash point of which is between 40 and 100° C.
in step c), the volatile oil is a light isoparaffin comprising from 8 to 11 carbon atoms selected, for example, from those sold under the names Isopar™ G, Isopar™ L, Isopar™ H or Isopar™ J.
in step c), the term “non-volatile oil (H)” denotes a fatty substance which is liquid at a temperature of 25° C. at atmospheric pressure.
in step c) the organic solution comprises, per 100% of its own mass, between 10% and 30% by mass of at least one emulsifying agent of water-in-oil type (S1), preferably between 15% and 20% by mass.
in step c), the emulsifying agent of water-in-oil type (S₁) is selected from the elements of the group consisting of sorbitan esters, polyglycerol esters, alkoxylated polyglycerol esters, polyglycol polyhydroxystearates, polyglyceryl polyhydroxystearates and alkoxylated polyglyceryl polyhydroxystearates.
in step c), the organic solution comprises at least one polymeric surfactant, such as polyesters with a molecular weight of between 1000 and 3000, products of the condensation between a poly(isobutenyl)succinic acid or the anhydride thereof and diethanolamine or lastly block copolymers with a molecular weight of between 2500 and 3500. This compound is introduced in an amount of 5% to 30% by mass into the fatty phase, and preferentially between 15% and 20%, to stabilize the emulsion produced in step e).
in step c), the emulsifying agent of water-in-oil type (S₁) is a polyglyceryl polyhydroxystearate.
step d) is performed so that the ratio by mass between the aqueous solution and the organic phase is between 90/10 and 10/90, preferably between 20/80 and 40/60.
in step e), the homogenization is performed under shearing mechanical stirring.
in step g), the emulsifying surfactant of oil-in-water type (S₂) is selected from the elements of the group consisting of a polyethoxylated fatty alcohol, a polyethoxylated hexitan ester, an alkyl polyglycoside, a composition of alkyl polyglycoside and of fatty alcohols, a polyglycerol ester, a composition of polyglycerol esters and of polyglycerols.
in step f) the distillation is performed under vacuum and with heating. The aim of this is to crosslink the polyglutamic acid and concentrate the inverse emulsion. The choice of a concentrated inverse emulsion process makes it possible to dissolve the starting poly-gamma-glutamic acid, its possible co-constituents, and also the crosslinking agent(s) in the aqueous phase of the emulsion. The production of the emulsion makes it possible to create droplets isolated from each other, enabling the crosslinking of the PGA without solidification of the reaction medium due to the increase in viscosity of the aqueous phase during the crosslinking step. The step of concentration by distillation of a light fatty phase leads to the production of a product in liquid form with an active material content of greater than 20%.

According to a more particular aspect of the process, for the purposes of the present invention, the term “volatile oil” denotes an element of the group consisting of branched alkanes, comprising from 7 to 40 carbon atoms, such as isododecane, isopentadecane, isohexadecane, isoheptadecane, isooctadecane, isononadecane or isoeicosane, or mixtures of some of them, such as those mentioned below and identified by their INCI name: C7-8 Isoparaffin, C8-9 Isoparaffin, C9-11 Isoparaffin, C9-12 Isoparaffin, C9-13 Isoparaffin, C9-14 Isoparaffin, C9-16 Isoparaffin, C10-11 Isoparaffin, C10-12 Isoparaffin, C10-13 Isoparaffin, C11-12 Isoparaffin, C11-13 Isoparaffin and C11-14 Isoparaffin.

According to an even more particular aspect of the process, for the purposes of the present invention, the term “volatile oil” denotes at least one element of the group consisting of isododecane, isohexadecane, C7-8 Isoparaffin, C8-9 Isoparaffin, C9-11 Isoparaffin, C11-13 Isoparaffin and C11-14 Isoparaffin.

According to another even more particular aspect of the process, the volatile oil is selected from an element of the group consisting of C8-9 Isoparaffin, C9-11 Isoparaffin, C11-13 Isoparaffin and C11-14 Isoparaffin.

According to another even more particular aspect of the present invention, the “volatile oil” is selected from an element of the group consisting of the isoparaffins sold under the brand names Isopar™ G, Isopar™ L, Isopar™ H and Isopar™ J.

According to a more particular aspect of the process, for the purposes of the present invention, the term “non-volatile oil (H)” denotes an element of the group consisting of:
linear alkanes comprising from 11 to 19 carbon atoms,
branched alkanes comprising from 11 to 40 carbon atoms, such as isododecane, isopentadecane, isohexadecane, isoheptadecane, isooctadecane, isononadecane or isoeicosane, or mixtures of some of them, such as those mentioned below and identified by their INCI name: C12-14 Isoparaffin, C12-20 Isoparaffin, C13-14 Isoparaffin, C13-16 Isoparaffin,
cycloalkanes optionally substituted by one or more linear or branched alkyl radicals;
white mineral oils, such as those sold under the following names: Marcol™52, Marcol™82, Drakeol™6VR, Eolane™130, Eolane™150;
hemisqualane (or 2,6,10-trimethyldodecane; CAS number: 3891-98-3), squalane (or 2,6,10,15,19,23-hexamethyltetracosane), hydrogenated polyisobutene or hydrogenated polydecene,
mixtures of alkanes comprising from 15 to 19 carbon atoms, said alkanes being linear alkanes, branched alkanes and cycloalkanes, and more particularly the mixture (M1) which comprises, per 100% of its mass:
   a proportion by mass of branched alkanes of greater than or equal to 90% and less than or equal to 100%,
a proportion by mass of linear alkanes of greater than or equal to 0% and less than or equal to 9%,
a proportion by mass of cycloalkanes of greater than or equal to 0% and less than or equal to 1%, and
   more particularly still, said mixture (M1) is characterized in that it comprises, per 100% of its mass:
   a proportion by mass of greater than or equal to 95% of branched alkanes,

linear alkanes and cycloalkanes and less than or equal to 100% comprising from 15 to 19 carbon atoms, and
a proportion by mass of greater than or equal to 0% and less than or equal to 5% of branched alkanes, linear alkanes and cycloalkanes comprising less than 14 carbon atoms, and linear alkanes and cycloalkanes comprising more than 20 carbon atoms.

For the purposes of the present invention, the term “linear alkanes” present in the mixture (M1) as defined above, and comprising from 15 to 19 carbon atoms, more particularly denotes the elements selected from the group consisting of n-pentadecane, n-hexadecane, n-heptadecane, n-octadecane and n-nonadecane.

For the purposes of the present invention, the term “branched alkanes” present in the mixture (M1) as defined above, and comprising from 15 to 19 carbon atoms, more particularly denotes the elements selected from the group consisting of isopentadecane, isohexadecane, isoheptadecane, isooctadecane and isononadecane.

The mixture (M1) is more particularly the mixture sold under the brand name Emogreen™ L15 by SEPPIC or else the mixture sold under the brand name Emogreen™ L19.
the fatty alcohol ethers of formula (XIV):

Z₁—O—Z₂ (XIV)

in which Z₁ and Z₂, which may be identical or different, represent a linear or

branched alkyl radical comprising from 5 to 18 carbon atoms, for example dioctyl ether, didecyl ether, didodecyl ether, dodecyl octyl ether, dihexadecyl ether, (1,3-dimethylbutyl) tetradecyl ether, (1,3-dimethylbutyl) hexadecyl ether, bis(1,3-dimethylbutyl) ether or dihexyl ether.
the monoesters of fatty acids and alcohols of formula (XV):

R′₁—(C═O)—O—R′₂ (XV)

in which R′₁—(C═O) represents a saturated or unsaturated, linear or branched, acyl radical comprising from 8 to 24 carbon atoms and R′₂ represents, independently of R′₁, a saturated or unsaturated, linear or branched, hydrocarbon chain comprising from 1 to 24 carbon atoms, for example methyl laurate, ethyl laurate, propyl laurate, isopropyl laurate, butyl laurate, 2-butyl laurate, hexyl laurate, methyl cocoate, ethyl cocoate, propyl cocoate, isopropyl cocoate, butyl cocoate, 2-butyl cocoate, hexyl cocoate, methyl myristate, ethyl myristate, propyl myristate, isopropyl myristate, butyl myristate, 2-butyl myristate, hexyl myristate, octyl myristate, methyl palmitate, ethyl palmitate, propyl palmitate, isopropyl palmitate, butyl palmitate, 2-butyl palmitate, hexyl palmitate, octyl palmitate, methyl oleate, ethyl oleate, propyl oleate, isopropyl oleate, butyl oleate, 2-butyl oleate, hexyl oleate, octyl oleate, methyl stearate, ethyl stearate, propyl stearate, isopropyl stearate, butyl stearate, 2-butyl stearate, hexyl stearate, octyl stearate, methyl isostearate, ethyl isostearate, propyl isostearate, isopropyl isostearate, butyl isostearate, 2-butyl isostearate, hexyl isostearate or isostearyl isostearate,
the diesters of fatty acids and of glycerol of formulae (XVI) and (XVII):

R′₃—(C═O)—O—CH₂—CH(OH)—CH₂—O—(C═O)—R′₄ (XVI)

R′₅—(C═O)'O—CH₂—CH[O—(C═O)—R′₆]—CH₂—OH (XVII)

in which R′₇—(C═O), R′₄—(C═O), R′₅—(C═O) and R′₆—(C═O), which may be identical or different, represent a saturated or unsaturated, linear or branched acyl group comprising from 8 to 24 carbon atoms.
the triesters of fatty acids and of glycerol of formula (XVIII):

R′₇—(C═O)—O—CH₂—CH[O—(C═O)—R″₈]—CH₂—O—(C═O)—R″₉ (XVIII)

in which R′₇—(C═O), R′₈—(C═O) and R′₉—(C═O), which may be identical or different, represent a saturated or unsaturated, linear or branched acyl group comprising from 8 to 24 carbon atoms.

According to another particular aspect of the present invention, said non-volatile oil (H) is selected from:
Undecane, tridecane, isododecane or isohexadecane,
Mixtures of alkanes and isoalkanes and cycloalkanes such as the mixture (M1) as defined previously and the mixtures sold under the names Emogreen™L15, Emogreen™L19, Emosmart™L15, Emosmart™L19, Emosmart™V21 and Isopar™M,
the white mineral oils sold under the names Marcol™52, Marcol™82, Drakeol™6VR, Eolane™130 or Eolane™150,
hemisqualane, squalane, hydrogenated polyisobutene or hydrogenated polydecene,
dioctyl ether or didecyl ether,
isopropyl myristate, hexyl palmitate, octyl palmitate, isostearyl isostearate, octanoyl/decanoyl triglyceride, hexadecanoyl/octadecanoyl triglyceride, and triglycerides derived from rapeseed oil, sunflower oil, linseed oil or palm oil.

According to another aspect, in step c) of the process that is the subject of the present invention, the term “emulsifying surfactant of water-in-oil type (S1)” denotes an emulsifying surfactant having an HLB value (Hydrophilic-Lipophilic Balance) that is low enough to induce the formation of an emulsion of water-in-oil type, namely an emulsion in which the aqueous phase will be dispersed and stabilized in the oily organic phase.

As emulsifying surfactant of water-in-oil type, examples that may be mentioned include anhydrohexitol esters of linear or branched, saturated or unsaturated aliphatic carboxylic acids comprising from 12 to 22 carbon atoms, optionally substituted with one or more hydroxyl groups, and more particularly esters of anhydrohexitols selected from anhydrosorbitols and anhydromannitols and of linear or branched, saturated or unsaturated aliphatic carboxylic acids comprising from 12 to 22 carbon atoms, optionally substituted with one or more hydroxyl groups.

In step c) of the process that is the subject of the present invention, the emulsifying system (S1) of water-in-oil type is more particularly selected from the elements of the group consisting of:
sorbitan laurate, for example the product sold under the name Montane™20,
sorbitan palmitate, for example the product sold under the name Montane™40, sorbitan stearate, for example the product sold under the name Montane™60,
sorbitan oleate, for example the product sold under the name Montane™80,
sorbitan sesquioleate, for example the product sold under the name Montane™83,
sorbitan trioleate, for example the product sold under the name Montane™85, sorbitan isolaurate,
sorbitan isostearate, for example the product sold under the name Montane™70,
mannitan laurate, mannitan oleate, or a mixture of these esters, polyesters with a molecular weight of between 1000 and 3000 g/mol and resulting from the condensation between a poly(isobutenyl)succinic acid or the anhydride thereof, such as Hypermer™ 2296, or the mixture sold under the brand name Simaline™IE 501 A.
the polyglycerol esters of formula (XIX):

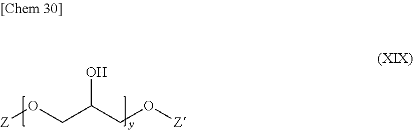

in which Z represents an acyl radical of formula R₂—C(═O)—, in which R₂ represents a saturated or unsaturated, linear or branched, aliphatic hydrocarbon-based radical, comprising from 11 to 35 carbon atoms, and more particularly a radical chosen from the dodecanoyl, tetradecanoyl, hexadecanoyl, octadecanoyl, eicosanoyl, docosanoyl, oleyl, linoleyl, linolenoyl or isostearyl radicals, Z′ represents the acyl radical of formula R₂—C(═O)— as defined above, with Z′ identical to or different from Z, or a hydrogen atom, and y represents an integer of greater than or equal to 2 and less than or equal to 20. According to a more particular aspect, the compound of formula (XIX) is selected from the elements of the group consisting of decaglyceryl oleate, decaglyceryl isostearate, decaglyceryl monolaurate, decaglyceryl monolinoleate and decaglyceryl monomyristate.

The alkoxylated polyglycerol esters of formula (XX):

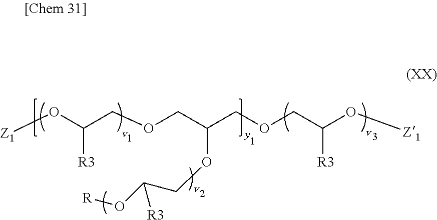

in which Z₁ represents an acyl radical of formula R′₂—C(═O)—, in which R′₂ represents a saturated or unsaturated, linear or branched, aliphatic hydrocarbon-based radical, comprising from 11 to 35 carbon atoms, and more particularly a radical selected from the dodecanoyl, tetradecanoyl, hexadecanoyl, octadecanoyl, eicosanoyl, docosanoyl, oleyl, linoleyl, linolenoyl or isostearyl radicals, Z′₁ represents the acyl radical of formula R′₂—C(═O)—as defined above, with Z′₁ identical to or different from Z₁, or a hydrogen atom, R₃ represents a hydrogen atom, the methyl radical or the ethyl radical, y₁ represents an integer of greater than or equal to 2 and less than or equal to 20, v₁, v₂ and v₃, which may be identical or different, represent an integer of greater than or equal to 0 and less than or equal to 50, and the sum [(y₁·v₁)+(y₁·v₂)+v₃] is an integer of greater than or equal to 1 and less than or equal to 50.

The polyglycol polyhydroxystearates of formula (XXI):

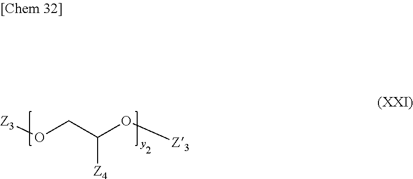

in which y₂ represents an integer of greater than or equal to 2 and less than or

equal to 50, Z₄ represents a hydrogen atom, the methyl radical or the ethyl radical, and Z₃ represents a radical of formula (XXII):

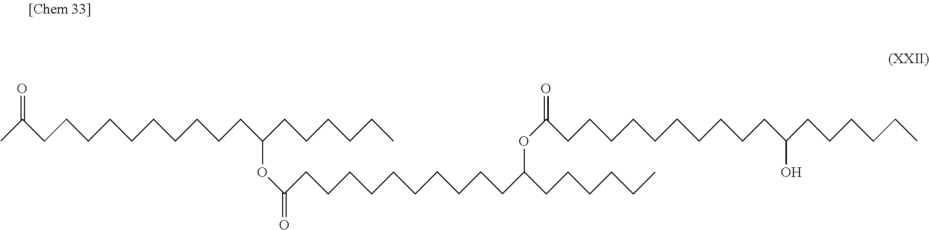

in which y′₂ represents an integer of greater than or equal to 0 and less than or equal to 10, more particularly greater than or equal to 1 and less than or equal to 10, and Z ′₃ represents a radical of formula (XXII) as defined above, with Z′3 identical to or different from Z₃, or a hydrogen atom.

Examples of emulsifying surfactant of water-in-oil type of formula (XXI) that may be used for preparing the emulsifying system (S1) include PEG-30 dipolyhydroxystearate, sold under the name Simaline™ WO, or else the mixtures comprising PEG-30 dipolyhydroxystearate and sold under the names Simaline™ IE 201 A and Simaline™ IE 201 B, or else the mixture comprising trimethylolpropane-30 tripolyhydroxystearate sold under the name Simaline™ IE 301 B.

The polyglycerol polyhydroxystearates represented by formula (XXIII):

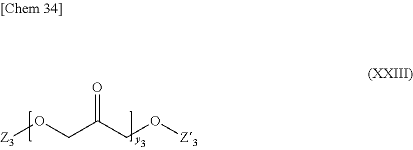

in which Z₃ represents a radical of formula (XXIII) as defined above, Z′₃ represents a radical of formula (XXII) as defined above, where Z3′ may be identical to or different from Z₃, or a hydrogen atom, y₃ represents an integer of greater than or equal to 2 and less than or equal to 20.

The alkoxylated polyglycerol polyhydroxystearates represented by formula (XXIV):

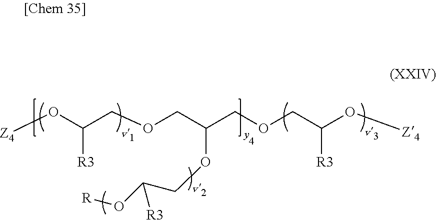

in which Z₄ represents a radical of formula (XXII) as defined above, Z′₄ represents a radical of formula (XXII) as defined above, with Z′₄ being identical to or different from Z₄, or a hydrogen atom, y₄ represents an integer of greater than or equal to 2 and less than or equal to 20, v′₁, v′₂ and v′₃, which may be identical or different, represent an integer of greater than or equal to 0 and less than or equal to 50, and the sum [(y₄·v′₁)+(y₄·v′₂)+v′₃)] is an integer of greater than or equal to 1 and less than or equal to 50.

According to another aspect, in step g) of the process which is a subject of the present invention, the term “emulsifying surfactant of oil-in-water type (S2)” denotes an emulsifying surfactant having a sufficiently high HLB value to induce the formation of an emulsion of oil-in-water type, namely an emulsion in which the oily organic phase will be dispersed and stabilized in the aqueous phase.

According to another aspect, in step g) of the process which is a subject of the present invention, as surfactant of oil-in-water type (S2), mention may be made of:

The polyethoxylated fatty alcohols denoted by the compounds of formula (XXV):

R″—O—(CH₂—CH₂—O)_{n′}—OH (XXV)

with R″ representing a linear or branched, saturated or unsaturated hydrocarbon-based radical, which may bear hydroxyl groups, comprising from 6 to 22 carbon atoms, and with n′ representing an integer of greater than or equal to 4 and less than or equal to 100. According to a more particular aspect, in formula (XXV), R″ represents a linear or branched, saturated hydrocarbon-based radical comprising from 10 to 22 carbon atoms. According to an even more particular aspect, the compound of formula (XXV) is a linear decyl alcohol ethoxylated with 6 mol of ethylene oxide, a linear decyl alcohol ethoxylated with 8 mol of ethylene oxide, a linear lauryl alcohol ethoxylated with 6 mol of ethylene oxide, a linear lauryl alcohol ethoxylated with 7 mol of ethylene oxide, a linear lauryl alcohol ethoxylated with 8 mol of ethylene oxide, a linear tridecyl alcohol ethoxylated with 6 mol of ethylene oxide, a linear tridecyl alcohol ethoxylated with 8 mol of ethylene oxide, or a linear tridecyl alcohol ethoxylated with 9 mol of ethylene oxide. Polyethoxylated hexitan esters, and particularly polyethoxylated sorbitan

esters, the aliphatic hydrocarbon-based chain of which comprises from 12 to 22 carbon atoms and in which the number of ethylene oxide units is between 5 and 40, for example sorbitan oleate ethoxylated with 20 mol of ethylene oxide, sold under the trade name Montanox™ 80, or sorbitan laurate ethoxylated with 20 mol of ethylene oxide, sold under the trade name Montanox™ 20.
The alkyl polyglycoside compositions (C1) represented by formula (XXVI):

R″₁—O-(G)ₓ-H (XXVI)

in which x, or the mean degree of polymerization, represents a decimal

number of between 1.05 and 5, G represents a reducing sugar residue, and R″₁ represents a saturated or unsaturated, linear or branched aliphatic hydrocarbon-based radical, optionally substituted with one or more hydroxyl groups, comprising from 12 to 36 carbon atoms, said composition (C1) consisting of a mixture of compounds represented by formulae (XXVI1), (XXVI2), (XXVI3), (XXVI4) and (XXVI5):

R″₁—O-(G)₁-H (XXVI1)

R″₁—O-(G)₂-H (XXVI2)

R″₁—O-(G)₃-H (XXVI3)

R″₁—O-(G)₄-H (XXVI4)

R″₁—O-(G)₅-H (XXVI5)

in the respective molar proportions a₁, a₂, a₃, a₄ and a₅ such that:
the sum a₁+a₂+a₃+a₄+a₅ is equal to 1 and that
the sum a₁+2a₂+3a₃+4a₄+5a₅ is equal to x.

The term “saturated or unsaturated, linear or branched aliphatic hydrocarbon-based radical comprising from 12 to 36 carbon atoms, optionally substituted with one or more hydroxyl groups” denotes, for the radical R″₁ in formula (XXVI) as defined above more particularly the n-dodecyl radical, the n-tetradecyl radical, the n-hexadecyl radical, the n-octadecyl radical, the n-eicosyl radical, the n-docosyl radical or the 12-hydroxyoctadecyl radical.

The term “reducing sugar” in the definition of formula (XXVI) as defined above denotes saccharide derivatives that do not have in their structures any glycoside bonds established between an anomeric carbon and the oxygen of an acetal group as defined in the reference work: “Biochemistry”, Daniel Voet/Judith G. Voet, p. 250, John Wiley & Sons, 1990. The oligomeric structure (G)ₓ can exist in all forms of isomerisms, whether it is optical isomerism, geometrical isomerism or positional isomerism. It can also represent a mixture of isomers.

In formula (XXVI) as defined above, the group R₁—O— is linked to G via the anomeric carbon of the saccharide residue, so as to form an acetal function.

According to a particular aspect in the definition of formula (XXVI) as defined above, G represents a reducing sugar residue selected from glucose, dextrose, sucrose, fructose, idose, gulose, galactose, maltose, isomaltose, maltotriose, lactose, cellobiose, mannose, ribose, xylose, arabinose, lyxose, allose, altrose, dextran and tallose; and more particularly, G represents a reducing sugar residue selected from glucose, xylose and arabinose residues.

According to an even more particular aspect, in the definition of formula (XXVI) x, or mean degree of polymerization, represents a decimal number of greater than or equal to 1.05 and less than or equal to 2.5, more particularly greater than or equal to 1.05 and less than or equal to 2.0 and more particularly still greater than or equal to 1.25 and less than or equal to 2.0.

The compositions (C2) comprising, per 100% of their mass: from 10% to 50% by mass, more particularly from 15% to 40% by mass and

more particularly still from 20% to 30% by mass, of at least one composition (C1) represented by formula (XXVI) as defined previously,
from 90% to 50% by mass, more particularly from 85% to 60% by mass, and more particularly still from 80% to 70% by mass, of at least one fatty alcohol of formula (XXVII):

R′″₁—OH (XXVII)

in which R′″₁, which may be identical to or different from R″₁, represents a saturated or unsaturated, linear or branched aliphatic hydrocarbon-based radical, optionally substituted with one or more hydroxyl groups, comprising from 12 to 36 carbon atoms and preferably from 12 to 22 carbon atoms.

The polyglycerol esters of formula (XXVIII):

R₁₂—(C═O)—[O—CH₂—CH(OH)—CH₂]ₚ₁₂—OH (XXVIII)

in which p12 represents an integer of greater than or equal to 1 and less than

or equal to 15 and in which the group R₁—(C═O)— represents a saturated or unsaturated and linear or branched aliphatic radical comprising from 6 to 22 carbon atoms.

The compositions (C3) comprising, per 100% of their mass:
from 10% to 60% by mass of at least one compound of formula (XXIX):

HO—[CH₂—CH(OH)—CH₂—O]ₙ₁₂—H (XXIX)

in which n12 represents an integer of greater than or equal to 1 and less than or equal to 15, and
from 40% to 90% by mass of at least one compound of formula (XXVIII) as

defined previously.

Lastly, the present invention also provides for:

The use of said composition (C_{A}) as defined above, as thickening and/or emulsifying and/or stabilizing agent for a detergent liquid aqueous composition for domestic or industrial use.
The use of said detergent liquid aqueous composition (F) according to the invention, for cleaning solid surfaces.
A process for cleaning a solid surface, characterized in that it comprises at least one first step of applying said detergent liquid aqueous composition (F) according to the invention to the solid surface, and a second step of rinsing said solid surface.

According to another particular aspect, said use of the composition (C_{A}), which is a subject of the present invention, consists in thickening polar phases such as, for example, aqueous, alcoholic or aqueous-alcoholic phases or polar phases comprising polyols such as glycerol.

According to another particular aspect, said use consists in stabilizing an emulsion of oil-in-water type, or of water-in-oil type, giving said emulsion a homogeneous appearance during storage under various conditions, and more particularly at 25° C. for a time at least equal to one month, and more particularly at 4° C. for a time at least equal to one month, and more particularly at 45° C. for a time at least equal to one month.

According to another particular aspect, said use consists in stabilizing solid particles in detergent liquid aqueous compositions for domestic or industrial use.

These solid particles to be suspended may have various regular or irregular geometries, and may be in the form of pearls, beads, rods, flakes, leaflets or polyhedra. These solid particles are characterized by an apparent mean diameter of between 1 μm and 5 mm, more particularly between 10 μm and 1 mm.

Among the solid particles that may be suspended and stabilized with the self-invertible inverse latex as defined above in detergent liquid aqueous compositions for domestic or industrial use are micas, iron oxide, titanium oxide, zinc oxide, aluminum oxide, talc, silica, kaolin, clays, boron nitride, calcium carbonate, magnesium carbonate, magnesium hydrogen carbonate, inorganic coloured pigments, polyamides such as Nylon-6, polyethylenes, polypropylenes, polystyrenes, polyesters, acrylic or methacrylic polymers such as polymethyl methacrylates, polytetrafluoroethylene, crystalline or microcrystalline waxes, porous spheres, selenium sulfide, zinc pyrithione, starches, alginates, plant fibers, loofah particles and sponge particles.

Said detergent liquid aqueous composition (F) that is the subject of the present invention is notably in the form of an aqueous solution, an emulsion or a microemulsion with an aqueous continuous phase, an emulsion or a microemulsion with an oily continuous phase, an aqueous gel, a foam, or else in the form of an aerosol. It may be applied directly by soaking, by spraying or by vaporizing onto the surface to be cleaned or else by means of any type of support intended to be placed in contact with the solid surface to be cleaned (paper, wipe, textile).

In general, said detergent liquid aqueous composition (F) which is a subject of the present invention also comprises ingredients usually used in the field of cleaning solid surfaces or textile fibers, such as nonionic, cationic or amphoteric surfactants, cationic or nonionic polymers, thickeners, enzymes, bleaching agents, anticorrosion agents, solvents, acidic agents, alkaline agents, anti-limescale agents, preserving agents, fragrances, colorants, repellents, oxidizing agents, detergency adjuvants, anti-soiling agents or anti-redeposition agents.

Among the detergent surfactants capable of being used for the preparation of the detergent liquid aqueous composition (F) as defined above, mention may be made of surfactants that give the detergent liquid aqueous composition (F) their ability to remove soiling present on the solid surfaces and to keep it in suspension, in order for it to then be removed during the rinsing step.

These detergent surfactants may be of anionic, cationic, amphoteric or nonionic nature.

Among the anionic detergent surfactants capable of being used for the preparation of the detergent liquid aqueous composition (F) as defined above, mention may be made of alkali metal salts, alkaline-earth metal salts, ammonium salts, amine salts, amino alcohol salts of alkyl ether sulfates, of alkyl sulfates, of alkylamido ether sulfates, of alkylaryl polyether sulfates, of monoglyceride sulfates, of alpha-olefin sulfonates, of paraffin sulfonates, of alkyl phosphates, of alkyl ether phosphates, of alkyl sulfonates, of alkylamide sulfonates, of alkylaryl sulfonates, of alkyl carboxylates, of alkyl sulfosuccinates, of alkyl ether sulfosuccinates, of alkylamide sulfosuccinates, of alkyl sulfoacetates, of alkyl sarcosinates, of acyl isethionates, of N-acyl taurates, of acyl lactylates, of N-acylated derivatives of amino acids, of N-acylated derivatives of peptides, of N-acylated derivatives of proteins, and of fatty acids.

Among the amphoteric detergent surfactants capable of being used for the preparation of the detergent liquid aqueous composition (F) as defined above, mention may be made of alkylbetaines, alkylamidobetaines, sultaines, alkylamidoalkylsulfobetaines, imidazoline derivatives, phosphobetaines, amphopolyacetates and amphopropionates.

Among the foaming and/or detergent amphoteric surfactants that may be associated with said self-invertible inverse latex as defined above in said detergent liquid aqueous composition (F), mention may be made of alkylbetaines, alkylamidobetaines, sultaines, alkylamidoalkylsulfobetaines, imidazoline derivatives, phosphobetaines, amphopolyacetates, amphopropionates, and sodium N-(2-carboxyethyl)-N-(2-ethylhexyl)-β-alaninate sold under the brand name Tomamine® 30 Amphoteric 400 Surfactant.

Among the cationic detergent surfactants capable of being used for the preparation of the detergent liquid aqueous composition (F) as defined above, mention may particularly be made of quaternary ammonium derivatives.

Among the nonionic detergent surfactants capable of being used for the preparation of the detergent liquid aqueous composition (F) as defined above, mention may particularly be made of alkyl polyglycosides containing a linear or branched, saturated or unsaturated aliphatic radical comprising from 8 to 16 carbon atoms, castor oil derivatives, polysorbates, coconut amides and N-alkylamines. Mention may also be made of alkoxylated monoglycerides, alkoxylated diglycerides, alkoxylated terpenic hydrocarbons such as ethoxylated and/or propoxylated α- or β-pinenes, containing from 1 to 30 oxyethylene and/or oxypropylene units, products resulting from the condensation of ethylene oxide or of propylene oxide with ethylenediamine, such as the Tetronic™ products sold by BASF, ethoxylated and/or propoxylated C8-C18 fatty acids containing from 5 to 25 mol of ethylene oxide and/or propylene oxide, ethoxylated fatty amides containing from 5 to 30 mol of ethylene oxide, ethoxylated amines containing from 5 to 30 mol of ethylene oxide, alkoxylated amidoamines containing from 1 to 50, preferably from 1 to 25 and most particularly from 2 to 20 mol of ethylene oxide and/or propylene oxide. Mention may also be made of block copolymers of ethylene oxide and of propylene oxide, and most particularly the block copolymers of ethylene oxide and of propylene oxide sold under the brand name Pluronic™ by the company BASF, for instance Pluronic™ PE 6100 and Pluronic™ PE 6200. It is also possible to incorporate defoaming nonionic surfactants of formula (A₁):

R₁—X—[(CH₂—CH(CH₃)—O)_{u′}—(CH₂—CH₂—O)_{v′}—Y]_{w′} (A₁)

in which R₁ represents a saturated or unsaturated, linear or branched hydrocarbon-based aliphatic radical comprising from 6 to 18 carbon atoms, X represents a nitrogen atom or an oxygen atom, u′ and v′, which may be identical or different, each represent an integer of between 1 and 50, w′ is either equal to 1 if X represents an oxygen atom, or equal to 1 or to 2 if X represents a nitrogen atom, and Y represents a blocking functional group selected from the elements of the group consisting of linear alkyl radicals comprising from 4 to 8 carbon atoms, for instance the butyl radical, the benzyl radical or a butylene oxide group. Among the defoaming nonionic surfactants of formula (A₁), mention may be made of the products sold under the brand name Tergitol™ by the company Dow Chemical, for instance Tergitol™ L61E and Tergitol™ L64E, Other sparingly foaming nonionic surfactants may have the following formula (A₂):

R₈—O-(S′)_{q′-H} (A₂)
in which S′ represents a reducing sugar residue selected from the elements of the group consisting of glucose, xylose and arabinose, R₈ represents a saturated, linear or branched hydrocarbon-based radical comprising from 6 to 10 carbon atoms and q′ represents a decimal number of greater than or equal to 1.05 and less than or equal to 5. As examples of sparingly foaming nonionic surfactants of formula (A₂) optionally present in said detergent liquid aqueous composition (F), mention may be made of hexyl polyglucosides, 2-ethylhexyl polyglucosides, n-heptyl polyglucosides and n-octyl polyglucosides.

Among the mineral acids that are particularly selected as acidic agents in said detergent liquid aqueous composition (F), mention may be made of hydrochloric acid, nitric acid, phosphoric acid, sulfuric acid, hypophosphorous acid, phosphorous acid, hypochlorous acid, perchloric acid, carbonic acid, boric acid, manganic acid, permanganic acid, chromic acid, periodic acid, iodic acid, hypoiodous acid, hydrobromic acid, hydroiodic acid and hydrofluoric acid.

Among the organic acids that are particularly selected as acidic agents in said detergent liquid aqueous composition (F), mention may be made of formic acid, acetic acid, propionic acid, benzoic acid, salicylic acid, oxalic acid, malonic acid, succinic acid, glutaric acid, adipic acid, glycolic acid, lactic acid, malic acid, maleic acid, tartaric acid, citric acid, sorbic acid, sulfamic acid, dihydroacetic acid, dimethylsulfamic acid, fumaric acid, glutamic acid, isopropylsulfamic acid, valeric acid, benzenesulfonic acid, xylenesulfonic acid, 2-ethylhexanoic acid, capric acid, caproic acid, cresylic acid, dodecylbenzenesulfonic acid, peracetic acid, monochloroacetic acid and gluconic acid.

Among the alkaline agents associated with said self-invertible inverse latex as defined above in said detergent liquid aqueous composition (F), mention may be made of the elements of the group consisting of alkali metal or alkaline earth metal hydroxides, for instance sodium hydroxide, potassium hydroxide, barium hydroxide and calcium hydroxide.

Among the anti-limescale agents associated with said self-invertible inverse latex as defined above in said detergent liquid aqueous composition (F), mention may be made of the elements of the group consisting of sequestrants, for instance sodium tripolyphosphate (TPP), ethylenediaminetetraacetate (EDTA), tetraacetylethylenediamine (TAED), methylglycine diacetate (MGDA), sodium nitrilotriacetate (Na₃NTA), sodium or potassium gluconate, sodium or potassium erythorbate, sodium or potassium polycarboxylates, and sodium citrate, of ion-exchange agents, for instance sodium zeolites or aluminosilicates, or lamellar sodium silicates, and precipitating agents, for instance calcium carbonate and sodium metasilicate. According to a more particular aspect, in said detergent liquid aqueous composition (F), the anti-limescale agent is selected from the elements of the group consisting of sodium metasilicate, sodium tripolyphosphate (TPP), ethylenediaminetetraacetate (EDTA), tetraacetylethylenediamine (TAED), methylglycine diacetate (MGDA), sodium nitrilotriacetate (Na3NTA), sodium gluconate, sodium citrate and calcium carbonate. The sequestrants, and more particularly the sequestrants described above,

have the effect of complexing calcium and magnesium ions to form water-soluble complexes which are then removed during rinsing. The ion-exchange agents, and more particularly the ion-exchange agents described above, have the effect of exchanging their sodium ions with calcium and magnesium ions. The precipitating agents, and more particularly the sequestrants described above, have the effect of removing the ions responsible for the hardness of water by forming insoluble calcium compounds, which are subsequently removed with the soiling on the cleaned surfaces. Among the thickeners and/or gelling agents that may be associated with said

self-invertible inverse latex as defined above in said detergent liquid aqueous composition (F), mention may be made of polysaccharides consisting only of monosaccharides, such as glucans or glucose homopolymers, glucomannoglucans, xyloglycans, galactomannans of which the degree of substitution (DS) of the D-galactose units on the main D-mannose chain is between 0 and 1, and more particularly between 1 and 0.25, such as galactomannans originating from cassia gum (DS=1/5), locust bean gum (DS=1/4), tara gum (DS=1/3), guar gum (DS=1/2) or fenugreek gum (DS=1).

Among the thickeners and/or gelling agents that may be associated with said self-invertible inverse latex as defined above in said detergent liquid aqueous composition (F), mention may be made of polysaccharides consisting of monosaccharide derivatives, such as sulfated galactans and more particularly carrageenans and agar, uronans and more particularly algins, alginates and pectins, heteropolymers of monosaccharides and of uronic acids, and more particularly xanthan gum, gellan gum, acacia gum exudates and karaya gum exudates, glucosaminoglycans. Among the thickeners and/or gelling agents that may be associated with said self-invertible inverse latex as defined above in said detergent liquid aqueous composition (F), mention may be made of cellulose, cellulose derivatives such as methylcellulose, ethylcellulose, hydroxypropylcellulose, silicates, starch, hydrophilic starch derivatives, and polyurethanes.

Among the thickeners and/or gelling agents that may be associated with said self-invertible inverse latex as defined above in said detergent liquid aqueous composition (F), mention may be made of inorganic thickeners, for instance clays, hectorite, saponite, sauconite, vermiculite or colloidal silica.

The thickeners present in composition (F) that is a subject of the present invention are used in amounts of between 0.1% and 10% by mass.

Among the abrasive agents that may be associated with said self-invertible inverse latex as defined above in said detergent liquid aqueous composition (F), mention may be made of materials of natural origin, for instance wood or kernel chips, inorganic abrasive materials such as oxides, quartzes, diatomaceous earths, colloidal silica dioxides, organic abrasive materials such as polyolefins, for instance polyethylenes and polypropylenes, polystyrenes, acetonitrile-butadiene-styrene resins, melamines, phenolic resins, epoxy resins or polyurethane resins. The abrasive agents present in composition (F) that is a subject of the present invention are used in amounts of between 5.0% and 30% by mass.

Among the solvents that may be associated with said self-invertible inverse latex as defined above in said detergent liquid aqueous composition (F), mention may be made of isopropyl alcohol, benzyl alcohol, 1,3-propanediol, chlorinated solvents, acetone, methyl ethyl ether, methyl isobutyl ether, butyl acetate, ethyl acetate, isopropyl acetate, isobutyl acetate, aromatic solvents, isoparaffins, isododecane, ethyl lactate, butyl lactate, terpenic solvents, rapeseed methyl esters, sunflower methyl esters, propylene glycol n-methyl ether, dipropylene glycol n-methyl ether, tripropylene glycol n-methyl ether, propylene glycol n-butyl ether, dipropylene glycol n-butyl ether, tripropylene glycol n-butyl ether, propylene glycol n-propyl ether, dipropylene glycol n-propyl ether, propylene glycol monomethyl ether acetate, propylene glycol diacetate, propylene glycol phenyl ether, ethylene glycol phenyl ether or dipropylene glycol dimethyl ether. As examples of solvents present in composition (F) that is a subject of the present invention, mention may be made more particularly of the elements of the group consisting of propylene glycol n-methyl ether, dipropylene glycol n-methyl ether, tripropylene glycol n-methyl ether, propylene glycol n-butyl ether, dipropylene glycol n-butyl ether, tripropylene glycol n-butyl ether, propylene glycol n-propyl ether, dipropylene glycol n-propyl ether, propylene glycol phenyl ether, ethylene glycol phenyl ether, dipropylene glycol dimethyl ether, rapeseed methyl esters and sunflower methyl esters.

Among the enzymes that may be associated with said self-invertible inverse latex as defined above in said detergent liquid aqueous composition (F), mention may be made of proteases, amylases, lipases, cellulases and peroxidases. The enzymes present in composition (F) that is a subject of the present invention are used in amounts of between 0.005% and 0.5% by mass.

According to another aspect, a subject of the invention is the use of said detergent liquid aqueous composition (F) as defined above, for cleaning solid surfaces. The expression for “cleaning solid surfaces” denotes any action intended for removing soiling present on surfaces consisting of various materials. The surfaces to be cleaned may be solid surfaces or textile surfaces. The term “solid surfaces” denotes, for example, floors, walls, window panes, tiles, household electrical appliances, kitchenware, countertops, tapware, sinks, tanks for storing chemical, food or agricultural products, vehicles (motor vehicles, motorbikes, trucks, etc.). The materials constituting these solid surfaces are, for example, glass (soda-lime, fluorocalcium, borosilicate, crystal), porcelain, earthenware, ceramic, polycarbonate or polypropylene plastics, stainless steel, silver, copper, aluminum, wood, synthetic resins, glass-ceramic or linoleum, and may be coated with paints or varnishes. As examples of soiling that is present on these solid surfaces and that is to be removed by cleaning, mention may for example be made of food residues, grease, light and heavy hydrocarbons, burnt residues, dust, sludge, finger marks, soap residues and microorganisms.

According to another aspect, a subject of the invention is a process for cleaning a solid surface, characterized in that it comprises at least one first step a″1) of applying said detergent liquid aqueous composition (F) as defined above, followed by at least one step b″1) of rinsing said solid surface.

In step a″1) of the process as defined above, said detergent liquid aqueous composition (F) is applied to the surface comprising the soiling to be cleaned by any means, for instance by total immersion, by spraying or by application by means of a support consisting of synthetic or natural, woven or nonwoven textile fibers, or paper, impregnated beforehand with said composition.

In step b″1) of the process as defined above, the rinsing of the solid surface onto which composition (F) for domestic or industrial use has been applied during step a″1) is performed by total immersion or by spraying with water. Step b″1) of the cleaning process that is a subject of the invention may be performed at ambient temperature or at a temperature of between 30 and 80° C., more particularly at a temperature of between 30 and 65° C.

### EXAMPLES

The examples that follow illustrate the invention without, however, limiting it.

### I—Examples of Preparation of Compositions (CA):

### Example I.1: Preparation of a Concentrated Water-In-Oil Emulsion According to the Invention, Composed of C15-19 Alkanes as Fatty Phase and Sodium PGGA Crosslinked with 1,4-Butanediol Diglycidyl Ether in Aqueous Phase (pH=5.5 to 6.0)

The synthesis process comprises the following steps:
Step a): Production of a sodium PGGA gel: 110 grams of demineralized water are placed under mechanical stirring provided by a Rayneri™ brand stirrer equipped with a deflocculator-type rotor and 30 grams of sodium PGGA sold under the brand name “Cosmetic Grade PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.45 grams of 1,4-butanediol diglycidyl ether, sold under the name Erisys™ GE 21 by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of C15-19 alkane sold under the name Emogreen™L19 by the company SEPPIC and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring provided by a Rayneri™ brand stirrer equipped with a deflocculator-type rotor.polygamma
Step f): Shearing emulsification provided by a Silverson™ L4RT brand rotor/stator type system for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (CA1) is isolated.

### Example I.2: Preparation of a Concentrated Water-In-Oil Emulsion According to the Invention, Composed of Ethylhexyl Palmitate as Fatty Phase and Sodium PGGA Crosslinked with 1,4-Butanediol Diglycidyl Ether in Aqueous Phase (pH=5.5 to 6.0)

The synthesis process comprises the following steps:
Step a): Production of a sodium PGGA gel: 120 grams of demineralized water are placed in a beaker under stirring provided by a Rayneri™ brand mechanical stirrer equipped with a deflocculator-type rotor and 20 grams of sodium PGGA sold under the brand name “Cosmetic Grade PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.50 grams of 1,4-butanediol diglycidyl ether, sold under the name Erisys™ GE 21 by the company Emerald, to the aqueous phase prepared in step a).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring provided by a Rayneri™ brand stirrer equipped with a deflocculator-type rotor.
Step f): Shearing emulsification with a Silverson™ L4RT brand rotor/stator type device for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (C_{A2}) is isolated.

### Example I.3: Preparation of a Concentrated Water-In-Oil Emulsion According to the Invention, Composed of an Ethylhexyl Palmitate/C15-19 Alkanes Mixture as Fatty Phase and Sodium PGGA Crosslinked with 1,4-Butanediol Diglycidyl Ether in Aqueous Phase (pH=5.5 to 6.0)

The synthesis process comprises the following steps:
Step a): Production of a sodium PGGA gel: 100 grams of demineralized water are placed in a beaker under stirring provided by a Rayneri™ brand mechanical stirrer equipped with a deflocculator-type rotor and 30 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.75 grams of 1,4-butanediol diglycidyl ether, sold under the name Erisys™ GE 21 by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 10 grams of ethylhexyl palmitate sold under the name DUB PO by the company Stéarinerie Dubois, 10 grams of C15-19 alkane sold under the name Emogreen™ L19 by the company SEPPIC, and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring by means of a Rayneri™ brand stirrer equipped with a deflocculator-type rotor.
Step f): Emulsification by shearing stirring with a rotor/stator type device with a Silverson™ L4RT brand stirrer for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

→After homogenization, the composition (C_{A3}) is isolated.

### Example I.4: Preparation of a Concentrated Water-in-Oil Emulsion According to the Invention, Composed of Ethylhexyl Palmitate as Fatty Phase and Sodium PGGA Crosslinked with 1,4-Butanediol Diglycidyl Ether in Organic Phase (pH=5.5 to 6.0)

The synthesis process comprises the following steps:
Step a): Production of a sodium PGGA gel: 120 grams of demineralized water are placed in a beaker under mechanical stirring by means of a Rayneri™ brand stirrer equipped with a deflocculator-type rotor and 20 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois, 30 grams of C11-12 isoparaffin sold under the name Isopar™ H by the company ExxonMobil Chemical and 0.50 grams of 1,4-butanediol diglycidyl ether sold under the name Erisys GE 21 by the company Emerald; the organic phase obtained is lastly homogenized using a magnetic stirrer and a magnetic stirrer bar.
Step d): Pre-emulsification: Addition of the organic phase prepared in step c) to the aqueous phase prepared in step b) under mechanical stirring by means of a Rayneri™ brand mechanical stirrer equipped with a deflocculator-type rotor.
Step e): Shearing emulsification with a stirrer equipped with a Silverson™ L4RT rotor/stator system for 2 minutes at a speed of 7500 rpm.
Step f): Distillation, in a reactor under partial vacuum, of the light oil and water.
Step g): Addition of a surfactant of oil-in-water type to the concentrated emulsion obtained in step f): Addition of 2 grams of polyglyceryl-6 laurate to 8 grams of concentrated emulsion.

After homogenization, the composition (C_{A4}) is isolated.

### Example I.5: Preparation of a Concentrated Water-in-Oil Emulsion According to the Invention, Composed of Ethylhexyl Palmitate as Fatty Phase and Sodium PGGA Crosslinked with 1,4-Butanediol Diglycidyl Ether in Aqueous Phase (pH=4)

The synthesis process comprises the following steps:
Step a): Production of a sodium PGGA gel: 120 grams of demineralized water are placed in a beaker under mechanical stirring by means of a Rayneri™ brand stirrer equipped with a deflocculator-type rotor and 20 grams of PGGA sold under the brand name “Cosmetic Grade Sodium PolyGammaGlutamate” by the company Lubon are slowly added into the vortex.
Step b): Adjustment of the pH of the reaction medium to 4.0 at a temperature of 20° C. using a 5 M HCl solution.
Step c): Addition of 0.50 grams of 1,4-butanediol diglycidyl ether, sold under the name Erisys™ GE 21 by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring with a Rayneri™ brand stirrer equipped with a deflocculator-type rotor.
Step f): Shearing emulsification with a Silverson™ L4RT for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (C_{A5}) is isolated.

### Example I.6: Preparation of a Concentrated Water-in-Oil Emulsion According to the Invention, Composed of Ethylhexyl Palmitate as Fatty Phase and Sodium PGGA Crosslinked with 1,4-Butanediol Diglycidyl Ether in Aqueous Phase (pH=10)

The synthesis process comprises the following steps:
Step a): Production of a sodium PGGA gel: 120 grams of demineralized water are placed under mechanical stirring by means of a Rayneri™ brand stirrer equipped with a deflocculator-type rotor and 20 grams of PGGA sold under the brand name “Cosmetic Grade Sodium PolyGammaGlutamate” by the company Lubon are slowly added into the vortex.
Step b): Adjustment of the pH of the reaction medium to 10.0 at a temperature of 20° C. using a 4 M NaOH solution.
Step c): Addition of 0.50 grams of 1,4-butanediol diglycidyl ether, sold under the name Erisys™ GE 21 by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring with a Rayneri™ brand stirrer equipped with a deflocculator-type rotor.
Step f): Shearing emulsification with a Silverson™ L4RT brand stirrer for 2 minutes at a speed of 7500 rpm.
Step g): Distillation, in a reactor under vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (C_{A6}) is isolated.

### Example I.7: Preparation of a Concentrated Water-in-Oil Emulsion According to the Invention, Composed of Ethylhexyl Palmitate as Fatty Phase and Sodium PGGA Crosslinked with 1,4-Butanediol Diglycidyl Ether and Lipophilized with C12-14 Glycidyl Ether in Aqueous Phase (pH=6)

The synthesis process comprises the following steps:
Step a): Production of a sodium PGGA gel: 120 grams of demineralized water are placed in a beaker under mechanical stirring with a Rayneri™ brand stirrer equipped with a deflocculator-type rotor and 20 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.5 grams of 1,4-butanediol diglycidyl ether, sold under the name Erisys™ GE 21 by the company Emerald, to the aqueous phase prepared in step b).
Step d): Addition of 2.0 grams of C12-14 glycidyl ether, sold under the name Erisys™ GE 08 by Emerald, to the aqueous phase prepared in step c).
Step e): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step f): Pre-emulsification: Addition of the organic phase prepared in step e) to the aqueous phase prepared in step d) under mechanical stirring with a Rayneri™ brand stirrer equipped with a deflocculator-type rotor.
Step g): Shearing emulsification with a Silverson™ L4RT brand stirrer for 2 minutes at a speed of 7500 rpm.
Step h): Distillation, in a reactor under partial vacuum, of the light oil and water.
Step i): Addition of a surfactant of oil-in-water type to the concentrated emulsion obtained in step h): Addition of 2 grams of polyglyceryl-6 laurate to 8 grams of concentrated emulsion.

After homogenization, the composition (C_{A7}) is isolated.

### Example I.8: Preparation of a Concentrated Water-in-Oil Emulsion According to the Invention, Composed of Ethylhexyl Palmitate as Fatty Phase and Sodium PGGA Crosslinked with Trimethylolethane Triglycidyl Ether in Aqueous Phase (pH=6.0)

The synthesis process comprises the following steps:
Step a): Production of a sodium PGGA gel: 120 grams of demineralized water are placed under mechanical stirring with a Rayneri™ brand stirrer equipped with a deflocculator-type rotor and 20 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.5 grams of trimethylolethane triglycidyl ether, sold under the name Erisys™ GE 31 by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring with a Rayneri™ brand stirrer equipped with a deflocculator-type rotor.
Step f): Shearing emulsification with a Silverson™ L4RT brand stirrer for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (C_{A8}) is isolated.

### Example I.9: Preparation of a Concentrated Inverse Latex of Crosslinked Sodium PGA According to the Invention in Octyl Palmitate

The synthesis process comprises the following steps:
Step a): Production of a sodium PGGA gel: 110 grams of demineralized water are placed under stirring in a beaker and stirred with a Rayneri™ brand mechanical stirrer equipped with a deflocculator-type rotor and 30 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.72 grams of 1,4-butanediol diglycidyl ether, sold under the name Erisys™ GE 21 by the company Emerald, to the aqueous phase prepared in step b).
Step d): Preparation of the organic phase: A 100 gram beaker is charged with 5 grams of sorbitan isostearate sold under the name Montane™70 by the company SEPPIC, 3 grams of a mixture consisting of tall oil diethanolamide sold under the brand name Simaline™ IE 200 by the company SEPPIC, 2 grams of a polymeric surfactant sold under the brand name Hypermer™ 6212 by the company Croda and 50 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring with a Rayneri™ brand stirrer equipped with a deflocculator-type rotor.
Step f): Shearing emulsification with a Silverson™ L4RT brand mechanical stirrer for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 1 gram of sorbitan oleate ethoxylated with 20 mol of ethylene oxide sold under the name Montanox™80 by the company SEPPIC to 8 grams of concentrated emulsion.

After homogenization, the composition (C_{A9}) is isolated.

### Example I.10: Preparation of a Concentrated Water-in-Oil Emulsion According to the Invention, Composed of Ethylhexyl Palmitate as Fatty Phase and Sodium PGGA Crosslinked with Ethylene Glycol Diglycidyl Ether (EGDGE) in Aqueous Phase (pH=6.0)

The synthesis process comprises the following steps:
Step a): Production of a sodium PGGA gel: 130 grams of demineralized water are placed under mechanical stirring with a Rayneri™ brand stirrer equipped with a deflocculator-type rotor and 10 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.25 grams of ethylene glycol diglycidyl ether, sold under the name Erisys™ EGDGE by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring with a Rayneri™ brand stirrer equipped with a deflocculator-type rotor.
Step f): Shearing emulsification with a Silverson™ L4RT brand stirrer for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (Cato) is isolated.

### Example I.11: Preparation of a Concentrated Water-in-Oil Emulsion According to the Invention, Composed of Ethylhexyl Palmitate as Fatty Phase and Sodium PGGA Crosslinked with 1,4-Butanediol Diglycidyl Ether in Aqueous Phase (pH=6.0)

The synthesis process comprises the following steps:
Step a): Production of a sodium PGGA gel: 100 grams of demineralized water are placed under mechanical stirring with a Rayneri™ brand stirrer equipped with a deflocculator-type rotor and 40 grams of PGGA sold under the brand name “Cosmetic Grade Sodium PolyGammaGlutamate” by the company Lubon are slowly added into the vortex.
Step b): Adjustment of the pH of the reaction medium to between 5.5 and 6.0 at a temperature of 20° C. using a 5 M HCl or 4 M NaOH solution.
Step c): Addition of 0.80 grams of 1,4-butanediol diglycidyl ether, sold under the name Erisys™ GE 21 by the company Emerald, to the aqueous phase prepared in step b).
Step d): Preparation of the organic phase: A 100 gram beaker is charged with 5 grams of sorbitan oleate sold under the name Montane™80 VG by the company SEPPIC, 5 grams of polyglyceryl-2 dipolyhydroxystearate sold under the name Dehymuls™ PGPH by the company BASF, 20 grams of ethylhexyl palmitate sold under the name DUB PO by the company Stéarinerie Dubois and 30 grams of C11-12 isoparaffin sold under the name Isopar™ H by the company ExxonMobil Chemical; the organic phase obtained is lastly homogenized using a magnetic stirrer and a magnetic stirrer bar.
Step e): Pre-emulsification: Addition of the organic phase prepared in step d) to the aqueous phase prepared in step c) under mechanical stirring with a Rayneri™ brand stirrer equipped with a deflocculator-type rotor.
Step f): Shearing emulsification with a Silverson™ L4RT brand stirrer for 2 minutes at a speed of 7500 rpm.
Step g): Distillation, in a reactor under partial vacuum, of the light oil and water.
Step h): Addition of a surfactant of oil-in-water type to the concentrated emulsion obtained in step g): Addition of 2 grams of polyglyceryl-6 laurate to 8 grams of concentrated emulsion.

After homogenization, the composition (C_{A11}) is isolated.

### II—Evaluations of the Compositions (C_{A1}) to (C_{A11}) According to the Invention:

The compositions (C_{A1}) to (C_{A11}) according to the invention are evaluated as described below:

Weigh out 192 grams of water in a 400 ml tall-form beaker.
Add, under mechanical stirring with a Rayneri™ brand stirrer equipped with a deflocculator-type rotor, 8 grams of compositions (C_{A1}) to (C_{A11}),
Leave stirring until a homogeneous gel is obtained,
Measure the dynamic viscosity of the homogeneous gels using a Brookfield™ RVT viscometer, at a speed of 5 rpm, choosing the appropriate spindle,
Add 0.1% by mass of sodium chloride to the gel previously produced and stir with a Rayneri™ brand mechanical stirrer equipped with a deflocculator-type rotor,
Then measure the dynamic viscosity of such a new gel using a Brookfield™ RVT brand viscometer at a speed of 5 rpm, choosing the appropriate spindle.

The results are collated in table 1 below.

TABLE 1

| | | Gel viscosity at 4% | | Gel viscosity |
|---|---|---|---|---|
| | Gel viscosity at | by mass of | | obtained in |
| | 4% by mass of | composition + | | step a) of the |
| | composition | 0.1% by mass | Equivalent | preparation process |
| | Brookfield ™ | NaCl Brookfield ™ | % by mass | Brookfield ™ |
| | RVT speed 5 | RVT speed 5 | of polymeric | RVT speed 5 |
| Composition | Spindle (x) | Spindle (x) | active material | Spindle (x) |
| Control test | 2% gel = 176 | 2% gel + | 2% | 2% gel = |
| “Cosmetic | mPa · s | 0.1% NaCl = | | 128 mPa · s |
| grade sodium | (Spindle 2) | 128 mPa · s | | (Spindle 2) |
| PGGA” sold by | | (Spindle 2) | | |
| the company | | | | |
| Lubon | | | | |
| Composition | 76 200 mPa · s | 73 000 mPa · s | 2% | 18 120 mPa · s |
| (C_{A1}) | (Spindle 6) | (Spindle 6) | | (Spindle 3) |
| Composition | 124 200 mPa · s | 89 400 mPa · s | 1.6% | 5040 mPa · s |
| (C_{A2}) | (Spindle 6) | (Spindle 6) | | (Spindle 3) |
| Composition | 91 600 mPa · s | 816 mPa · s | 2% | 18 120 mPa · s |
| (C_{A3}) | (Spindle 6) | (Spindle 3) | | (Spindle 3) |
| Composition | 117 200 mPa · s | 58 600 mPa · s | 1.6% | 5040 mPa · s |
| (C_{A4}) | (Spindle 6) | (Spindle 6) | | (Spindle 3) |
| Composition | 9820 mPa · s | 8860 mPa · s | 1.6% | 5040 mPa · s |
| (C_{A5}) | (Spindle 3)* | (Spindle 6)* | | (Spindle 3) |
| Composition | 131 800 mPa · s | 102 800 mPa · s | 1.6% | 5040 mPa · s |
| (C_{A6}) | (Spindle 6)* | (Spindle 6)* | | (Spindle 3) |
| Composition | 167 600 mPa · s | 118 400 mPa · s | 1.6% | 5040 mPa · s |
| (C_{A7}) | (Spindle 6) | (Spindle 6) | | (Spindle 3) |
| Composition | 9540 mPa · s | 8860 mPa · s | 1.6% | 5040 mPa · s |
| (C_{A8}) | (Spindle 3) | (Spindle 3) | | (Spindle 3) |
| Composition | 91 800 mPa · s | 34 600 mPa · s | 1.33% | 18 120 mPa · s |
| (C_{A9}) | (Spindle 6) | (Spindle 6) | | (Spindle 3) |
| Composition | 78 000 mPa · s | 600 mPa · s | 1% | 900 mPa · s |
| (C_{A10}) | (Spindle 6) | (Spindle 2) | | (Spindle 3) |
| Composition | 74 800 mPa · s | 48 400 mPa · s | 2.28% | 50 000 mPa · s |
| (C_{A11}) | (Spindle 6) | (Spindle 6) | | (Spindle 6) |

Viscosity values of the gels at pH 6.

Dynamic viscosities of the aqueous gels obtained with the compositions (CA1) to (CA11). Compositions (C_{A1}) to (CA₁₁) according to the invention make it possible to obtain thickened aqueous gels compared to the aqueous gel obtained from a non-crosslinked sodium gamma-polyglutamate (“control test”).

Thus, at a polymeric percentage by mass equal to 2%, the aqueous gels obtained with the compositions (C_{A1}) and (C_{A3}) exhibit viscosities of 76 000 and 91 600 mPa·s, respectively, whereas the aqueous gel obtained with non-crosslinked sodium gamma-polyglutamate (“control test”) features a viscosity of 176 mPa·s.

Similarly, at a polymeric percentage by mass of less than 2%, the aqueous gels obtained with the compositions (C_{A2}), (C_{A4}), (C_{A8}), (C_{A9}) and (C_{A10}) respectively exhibit viscosities of 124 000, 117 200, 9540, 91 800 and 78 000 mPa·s, whereas the aqueous gel obtained with 2% by mass of non-crosslinked sodium gamma-polyglutamate (“control test”) features a viscosity of 176 mPa·s.

### III—Examples of Preparation of Detergent Compositions (F)

In the formulations below, the percentages are expressed as percentages by mass per 100% of the mass of the formulation.

### Example III.1: Cleaning Composition (F1) for Ovens and Cooking Grills

Ingredients Content by mass
Simulsol™ OX 1309 L(1) 2%
Simulsol™ SL7 G(2) 2%
Composition (C_{A}1) 6%
Sodium hydroxide 25%
Water q.s. for 100%
(1): Simulsol™ OX 1309 L: Detergent surfactant composition sold by the company SEPPIC, comprising polyethoxylated alcohols resulting from the reaction of 1 molar equivalent of an alcohol sold under the brand name Exxal™13 with 9 molar equivalents of ethylene oxide.
(2): Simulsol™ SL7 G: Solution of n-heptyl polyglucosides, hydrotropic and solubilizing agent sold by the company SEPPIC.

The preparation of the composition (F1) involves the following steps:
a) A pre-gel is prepared at 20° C. by adding Simulsol™ OX 1309 L and then Simulsol™SL7 G to water. Composition (C_{A1}) according to the invention is then introduced into the aqueous solution and mixed until a gel of stable viscosity is obtained.
b) Sodium hydroxide is then gradually introduced under mechanical stirring at a temperature of 20° C. until a homogeneous gel is obtained. The gel obtained on conclusion of step b) is of homogeneous and clear appearance, with a viscosity of 10 000 mPa·s (Brookfield LVT at a speed of 6 rpm). After a period of storage of 6 months at 25° C., the gel obtained on conclusion of step b) of this procedure has a homogeneous and clear appearance, with a viscosity of 12 000 mPa·s (Brookfield LVT at a speed of 6 rpm).

The cleaning process is as follows:

The composition prepared above is sprayed at ambient temperature onto the walls of an oven soiled with food grease and onto cooking grills also soiled with food grease. After 10 minutes, the walls of the oven and the cooking grills are rinsed with hot water at 60° C. The walls of the oven and the surfaces of the cooking grills thus cleaned no longer have any soiling.

### Example III.2: Cleaning Composition (F2) for Aluminum Surfaces

Ingredients Content by mass
Simulsol™ OX 1309 L(1) 3%
Simulsol™ SL7 G 3%
Composition (C_{A2}) 5%
75% phosphoric acid 40%
Hordaphos™ MDGB 1% ⁽3) 5%
Dipropylene glycol methyl ether 5%
Water q.s. for 100%
(3): Hordaphos™ MDGB is a composition based on phosphoric esters, used as an anticorrosion agent.

Composition (F2) is prepared as follows:

Each ingredient is successively introduced into a mixing tank under moderate mechanical stirring, at ambient temperature, until a homogeneous and clear composition is obtained. Stirring is maintained for 30 minutes at 20° C. The composition obtained has a measured pH of less than 1.0 and is clear and homogeneous after storage for a period of one month at 40° C.

The cleaning process is as follows:

The composition prepared in the preceding paragraph is diluted to 3% in water and the solution thus obtained is sprayed onto the aluminum wall to be cleaned. This wall is then rinsed with hot water at 60° C.

1. A detergent composition for domestic or industrial use comprising at least one detergent surfactant and, as thickening agent, a composition in the form of an emulsion of self-invertible water-in-oil type comprising, per 100% of its mass, a content by mass of greater than or equal to 20% of a polymer consisting of monomer units derived from partially or totally salified glutamic acid and of units derived from at least one crosslinking agent bearing at least two glycidyl functions.

2. The detergent composition as claimed in claim 1, wherein, in the composition, the crosslinking agent is selected from the members of the group consisting of:
ethylene glycol diglycidyl ether of formula (I): 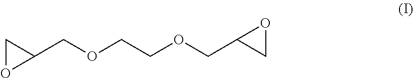 [SMILES: C(COCC1CO1)OCC1CO1]
the compound of formula (II): 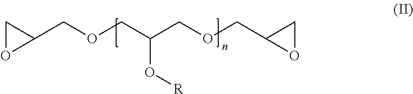
with R representing a hydrogen atom or the glycidyl radical 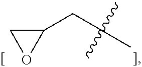 [SMILES: *CC1CO1]
and n representing an integer of greater than or equal to 1 and less than or equal to 10,
1,3-propanediol diglycidyl ether of formula (III): 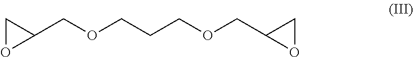 [SMILES: C(COCC1CO1)COCC1CO1]
1,2-propanediol diglycidyl ether of formula (IV): 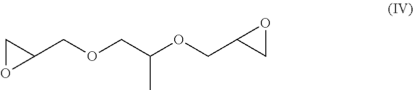
1,4-butanediol diglycidyl ether of formula (V): 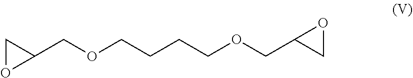 [SMILES: C(CCOCC1CO1)COCC1CO1]
1,2-butanediol diglycidyl ether of formula (VI): 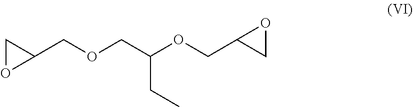
1,3-butanediol diglycidyl ether of formula (VII): 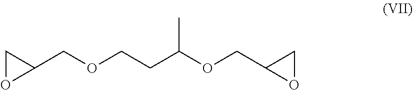
1,6-hexanediol diglycidyl ether of formula (VIII): 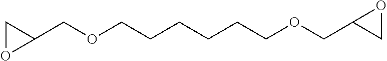 [SMILES: C(CCCOCC1CO1)CCOCC1CO1]
the compound of formula (IX): 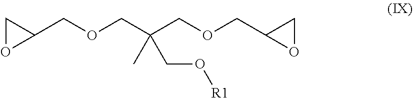
with R₁ representing a hydrogen atom or the glycidyl radical 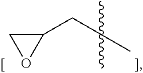 [SMILES: *CC1CO1]
the compound of formula (X): 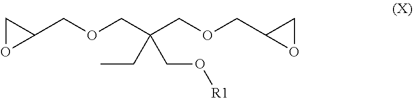
with R₁ representing a hydrogen atom or the glycidyl radical 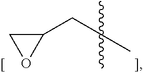 [SMILES: *CC1CO1]
the compound of formula (XI): 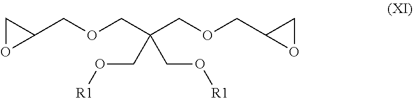
with R₁ and R₂ independently representing a hydrogen atom or the glycidyl radical 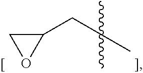 [SMILES: *CC1CO1]
the compound of formula (XII): 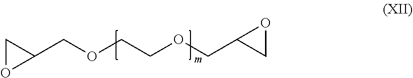
with m representing an integer of greater than or equal to 2,
the compound of formula (XIII): 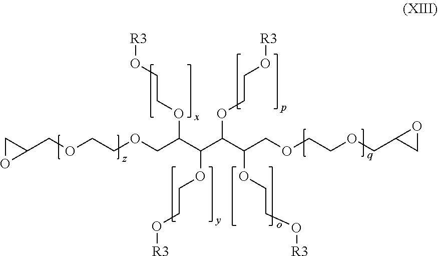
with R₃ representing a hydrogen atom or the glycidyl radical 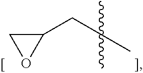 [SMILES: *CC1CO1]
and x, y, z, o, p and q independently of one another representing an integer of greater than or equal to 2 and less than or equal to 10.

3. The detergent composition as claimed in claim 1, wherein, in the composition, the polymer is gamma-polyglutamic acid in acid form or partially or totally salified form.

4. The detergent composition as claimed in claim 1, wherein, in the composition, the polymer, per 100 mol % of monomer units derived from partially or totally salified glutamic acid, the crosslinking agent represents from 0.5 to 20 mol %.

5. The detergent composition as claimed in claim 1, wherein the composition has a viscosity of between 100 and 10 000 mPa·s.

6. The detergent composition as claimed in claim 1, wherein the composition further comprises a monomer unit derived from the compound of formula (X′): 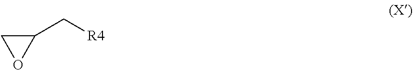
with R4 representing a linear or branched, saturated or unsaturated, functionalized or non-functionalized hydrocarbon-based radical comprising from 6 to 22 carbon atoms.

7. The detergent composition as claimed in claim 1, wherein it comprises between 0.1% and 10% by mass of said composition.

8. The detergent composition as claimed in claim 1, wherein the surfactant is selected from anionic, cationic, amphoteric and nonionic detergent surfactants.

9. A process for preparing a detergent composition as defined in claim 1, comprising the following 2 steps:
a step A) of preparing the composition, comprising the following substeps:
a) a step of preparing an aqueous solution comprising partially or totally salified polyglutamic acid, with said aqueous solution comprising, per 100% of its mass, between 5% and 70% by mass of partially or totally salified PGA and a crosslinking agent comprising at least two glycidyl functions,
b) a step of adjusting the pH of the aqueous solution obtained in step a) to a pH of between 3 and 11,
c) a step of preparing an organic phase containing at least one volatile oil, at least one other, non-volatile, oil and at least one emulsifying surfactant of water-in-oil type,
d) a step of pre-emulsification by adding, with stirring, the organic phase obtained in step c) to the aqueous solution obtained in step b),
e) a step of emulsifying the pre-emulsion obtained in step d) by homogenization with stirring,
f) a step of distilling the water and volatile oil contained in the emulsion obtained in step e),
g) a step of adding at least one emulsifying surfactant of oil-in-water type so as to obtain the composition,
a step B) of mixing at least one composition prepared in step A) with at least one surfactant.

10. The process as claimed in claim 8, wherein, in step a), the polyglutamic acid used is gamma-polyglutamic acid.

11. The process as claimed in claim 8, wherein, in step a), all of the monomer units constituting the gamma-polyglutamic acid are derived from sodium glutamate, potassium glutamate, ammonium glutamate, calcium glutamate, magnesium glutamate or a mixture of these forms.

12. The process as claimed in claim 8, wherein, in step a), the crosslinking agent is present in proportions by mass of between 0.5% and 10% by mass relative to the mass of polyglutamic acid.

13. The process as claimed in claim 11, wherein the crosslinking agent is selected from the members of the group consisting of the compounds of formulae (I), (II), (IIa), (IIb), (IIc), (IId), (III), (IV), (V), (VI), (VII), (VIII), (IX), (IXa), (IXb), (X), (Xa), (Xb), (XI), (XIa), (XIb), (XIc), (XII) and (XIII).

14. The process as claimed in claim 8, wherein, in step a), the aqueous phase further comprises at least one compound of formula (X′): 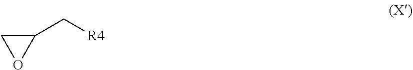
with R₄ representing a linear or branched, saturated or unsaturated, functionalized or non-functionalized hydrocarbon-based radical comprising from 6 to 22 carbon atoms.

15. The process as claimed in claim 8, wherein, in step c), the emulsifying agent of water-in-oil type is selected from the elements of the group consisting of sorbitan esters, polyglycerol esters, alkoxylated polyglycerol esters, polyglycol polyhydroxystearates, polyglyceryl polyhydroxystearates and alkoxylated polyglyceryl polyhydroxystearates.

16. The use of said composition as defined in claim 1, as thickening and/or emulsifying and/or stabilizing agent for a detergent liquid aqueous composition for domestic or industrial use.

17. The use of said detergent liquid aqueous composition as defined in claim 1, for cleaning solid surfaces.

18. A process for cleaning a solid surface, wherein it comprises at least one first step of applying said detergent liquid aqueous composition as defined in claim to the solid surface, and a second step of rinsing said solid surface.
